(19) United States
(12) Patent Application Publication
(10) Pub. No.: US 2015/0102141 A1
(43) Pub. Date: Apr. 16, 2015

(54) METHOD FOR REDUCING THE LOSSES OF VALUABLE SUBSTANCES IN MINERAL PROCESSING

(71) Applicant: K+S Aktiengesellschaft, Kassel (DE)

(72) Inventors: Jens Werdelmann, Heringen (DE); Jochen Brod, Wuestfeld (DE); Hermann Wotruba, Aachen (DE)

(73) Assignee: K+S Aktiengesellschaft, Kassel (DE)

(21) Appl. No.: 14/395,710

(22) PCT Filed: Apr. 19, 2013
(86) PCT No.: PCT/DE2013/000210

§ 371 Date: Oct. 20, 2014

(30) Foreign Application Priority Data
Apr. 19, 2012 (DE) 10 2012 008 094.8

(51) Int. Cl. B03B 7/00; C01D 3/08; C01F 11/18; B03D 1/08

(52) U.S. Cl. CPC B03B 7/00; B03D 1/08; C01D 3/08; C01F 11/185
USPC 241/20

(57) ABSTRACT

The invention relates to a method for reducing the losses of valuable substances in mineral processing, wherein a mineral mixture, dry or suspended, has a grain fraction with a tailings portion and a superficial valuable material portion after a first separation stage, and the tailings portion quantitatively exceeds the valuable material portion, the mineral mixture being suspended, insofar as it is not already a suspension, for the agglomeration of grains of the grain fraction with the valuable material portion, and a substantially hydrophobic agent with a content of anionic or cationic amphiphilic molecules is added to the suspended mineral mixture in order to wet the surface of the valuable substance portion to form agglomeration bridges between the valuable material portions of the grains, wherein the mineral mixture is routed in a solution saturated with the valuable material portion and the tailings to a wet separation stage for classification into a fraction richer in valuable material and a fraction less rich in valuable material, wherein separation in the wet separation stage is performed with the aid of a liquid film flow, the fraction richer in valuable material discharged from the wet separation stage being wet-ground, and the wet-ground fraction being fed to a further classification stage.

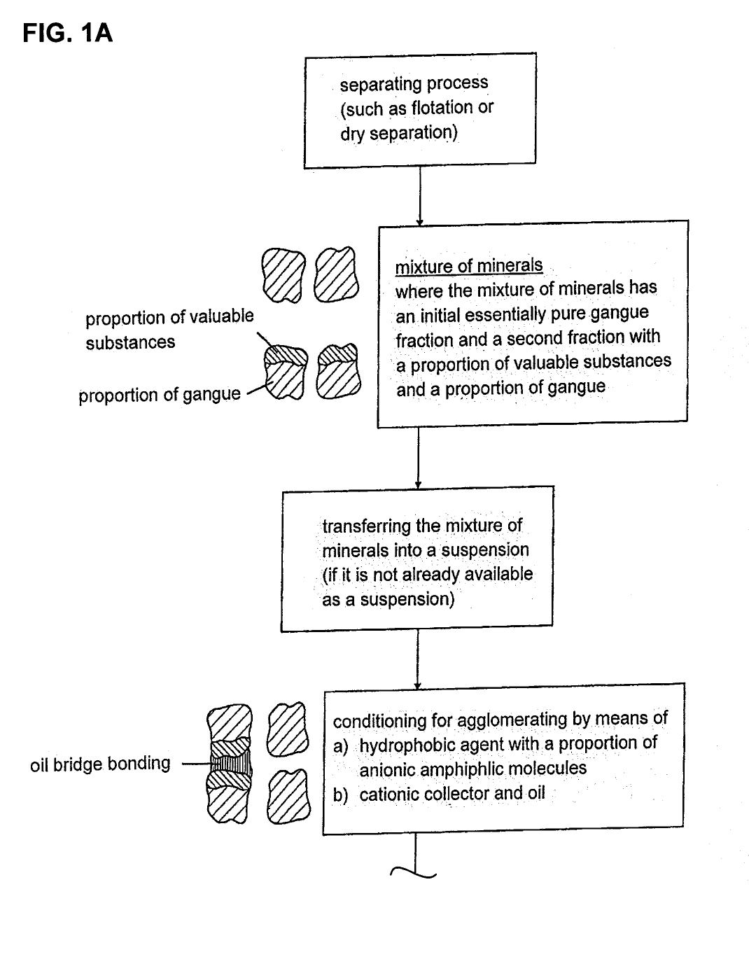

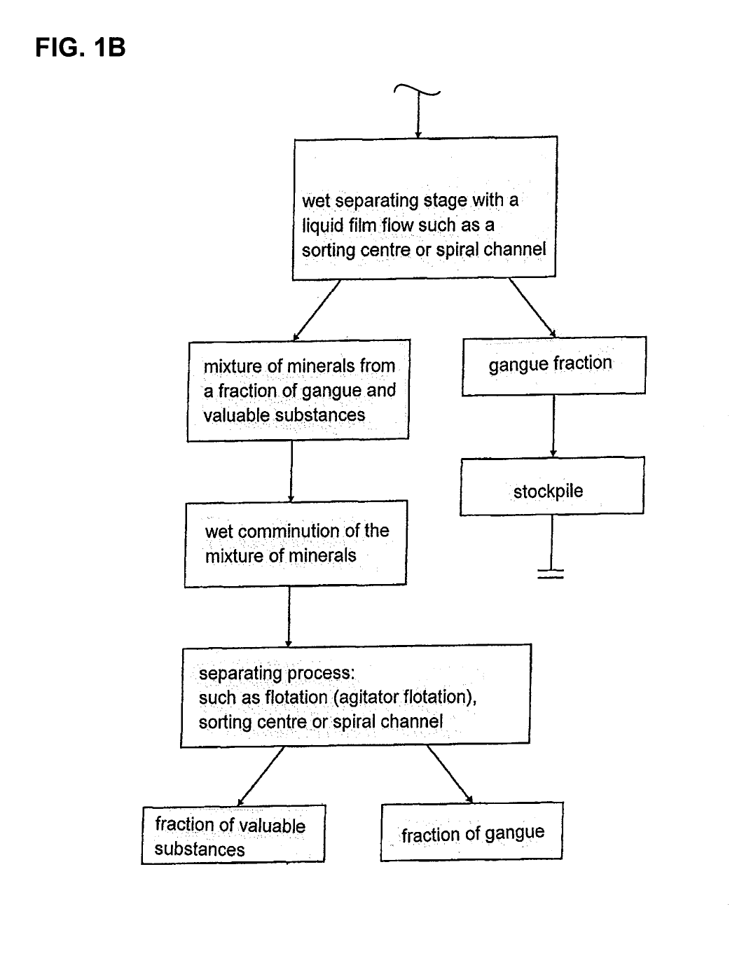

This invention concerns a process for reducing the losses of valuable substances when preparing minerals. Flotation, for example flotation as agitator flotation, is one of the best known and most effective processes for preparing such things as crude sylvinitic salts and extracting such things as fertiliser containing KCl.

The differences in the physical properties of the components of mixtures of minerals are primarily used in mineral preparation to separate them and normally enrich one component. For instance, the components of solids mixtures can be separated in an electrical or magnetic field due to their size, granular form, density or differing behaviour. Where these separating properties of the components of solids mixtures are not immediately available, they can be mediated with process materials. That means that process materials make opposite direction charging of components possible altogether with electrostatically sorting or a selective hydrophobic effect of a component during flotation.

The properties of the emerging agglomerates may differ substantially from those of the selectively linked components due to process materials from which such things as liquid bridges emerge between particles of a component or with which certain particles are linked in any fashion to more or less stable agglomerations or flakes. If these agglomerate properties form a better difference than the agglomerated component itself in features such as greater flow resistance in relation to the other components, it is possible to take advantage of this as a criterion for sorting.

The selective intensity of a difference in features by means of process materials is especially successful when the fractions to be separated have pure components. In turn, the purity of components depends on the degree of composition with natural mineral systems. In general, we may expect that the components in the fractions of these systems that are fine as dust are extensively accessible so that they are essentially available in the pure form. This is the reason why the fractions that are as fine as dust offer a good starting point for applying selective agglomeration or also flocculation.

Processes for flocculating with salt flotation form state-of-the-art processes that reduce the existing electrostatic repulsion forces of secondary minerals by means of process polymer flocculants and consequently lay the groundwork for an agglomeration process that stops the non-selective entrainment of these fractions into the foam product by improved sedimentation properties of gangue fractions fine as dust and that furthermore also have an impact on the thickening of gangue sludges and their filterability.

It is known from DE 23 009 538 that it is necessary to initially remove the relatively fine attendant materials such as clays and silicates by means of mechanical separation in order to effectively extract silvine from crude silvine salts by means of flotation. As an alternate to mechanical separation, it was discovered that these clays and silicates can be removed by a process where the suspended crude salt is subjected to selective flocculation by means of a high-molecular anionic or non-ionic polyacrylate, adding a cationic tenside and then subsequent flotation.

U.S. Pat. No. 3,438,745 describes the application of agglomeration aids for reclaiming salt solutions that accumulate after washing crude sylvinitic salts. First of all, fine attendant material (in particularly clayey components) are supposed to be separated when washing and thickened by using economic flocculation aids and subsequent centrifuging so that the proportion of the salt solution remaining in the solid clayey cake is minimised.

U.S. Pat. No. 4,693,830 delves into the flocculation of finely distributed solids using water-soluble polymers with an anionic character as a conventional process for separating these solids from process solutions of mineral and coal preparation.

The thing that all of the aforementioned processes have in common is the fact that the residue accumulating after the separating process still exhibits a proportion of valuable substances in the range of 2 to 3 weight % after separating any residues collecting. Silvine as a raw material for the fertiliser industry is highly sought-after, although the storage places for extracting silvine are limited. Due to the great demand for fertiliser containing KCl and the limited deposits of crude salt, there is now an interest in reducing the proportion of silvine, i.e. valuable substance in the dirt. There are grain-size categories in the dirt with a grain size of as much as some millimetres. Here, there are grains consist 100% of a proportion of gangue and grains that still have a proportion of valuable substances. That means that there are grains that consist both of a proportion of gangue and a proportion of valuable substances.

The objective that this invention is predicated on is reducing the proportion of valuable substances in a mixture of minerals that altogether has a relatively high proportion of gangue measuring 97% in order to extract additional KCl.

In this context, we could now imagine comminuting the residue wet once again to put the wet comminuted mixture of minerals to repeated separation. However, it has come to light that because of the quantity accumulating the time and effort is much too high which means that a process such as this does not make economic sense.

In accordance with the first type, a more economic procedure emerges for reducing the losses of valuable substances with mineral preparation, in particular when using the invention to extract silvine with the features of claim 1. Here, the mixture of minerals has a grain-size category with a proportion of gangue and a superficial proportion of valuable substances where the proportion of gangue is greater than the proportion of valuable substance, where the mixture of minerals is suspended (if it is not already available as a suspension) to agglomerate the grains of the grain-size category with the proportion of valuable substances. Furthermore, an agent that is essentially hydrophobic is added to the suspended mixture of minerals with a proportion of anionic amphiphilic molecules for wetting the surface of the proportion of valuable substances in order to form agglomeration bridges between the proportion of valuable substances of the grains, where the mixture of minerals is transferred in a solution saturated at the proportion of valuable substances and proportion of gangue in a wet separation stage for classification into a fraction that has less valuable substances and a fraction that has more valuable substances, where it is separated in the wet separation stage with the aid of a liquid film flow, where the fraction that has more valuable substances and is discharged from the wet separation stage is comminuted wet, where the wet comminuted fraction is led to another classification stage. This specifically envisions the hydrophobant agent is an oil that either already contains a natural anionic tenside or that at least one anionic tenside is added to at least one oil. Finally, the oil has one component in a fee fatty acid where the fee fatty acid can in particular be an oleic acid.

In accordance with another type, a procedure emerges for reducing the losses of valuable substances when using the invention for mineral preparation with the features of claim 6. This is a mixture of minerals in a solution saturated on the valuable substances and gangue after the first separation stage where the mixture of minerals has a grain-size category with a proportion of gangue and a superficial proportion of valuable substances where the proportion of gangue is in excess of the proportion of valuable substances, where the mixture of minerals is suspended (if it is not already available as a suspension) to agglomerate the grains of the grain-size category with the proportion of valuable substances, a cationic tenside and an oil are added to the suspended mixture of minerals for wetting the surface of the proportion of valuable substances in order to form liquid bridges between the proportion of valuable substances of the grains, where the mixture of minerals is transferred after agglomeration in a wet separation stage for classifying into a fraction that has less valuable substances and a fraction that has more valuable substances, where it is separated in a wet separation stage with the aid of a liquid film flow, where the fraction that has more valuable substances and is discharged from the wet separation stage is comminuted wet and where the wet comminuted fraction is fed to another classification stage. Here, the cationic tenside and the oil can be added as a mixture or separately, where the cationic tenside can be formed as a fatty amine. The oil itself is formed advantageously as a vegetable oil, which is beneficial in particular in terms of environmental protection.

At least one volatile substance extracted from oil such as kerosene or diesel may be used instead of or in addition to the oil.

The two types described above bring about a substantial reduction in the losses of valuable substances with a residue of as much as 60%. An increase such as this in the proportion of valuable substances is amazing considering that the gangue is clearly predominant in the grown grain over the proportion of valuable substances.

For instance, the slight superficial proportions of sylvine in the grain that would otherwise be made predominantly of rock salt with the usual flotation so that might make us assume that these components would not be sufficiently covered with process materials in usual flotation so that the stability of bridge formation based on hydrophobic interactions (if it takes place at all) would not be sufficient for selective agglomeration when carrying out the usual flotation. The selective agglomeration of the solid particles in a suspension ensures when using the invention that liquid bridge bonding is formed between the proportion of valuable substances by means of an essentially hydrophobic liquid of sufficient (i.e., lower) viscosity (preferably an oil and in particular an vegetable oil) so that agglomerates form in this fashion, where the capillary bonding forces are sufficient for stabilising the agglomerates with a sufficient amount of oil in a subsequent separating process particularly with one wet separation stage. If the proportion of valuable substances is not naturally hydrophobic, it is then necessary to add amphiphilic molecules, such as tensides to forming something akin an absorption layer that in the final analysis acts as an anchor for the oil, where the oil can be a mineral oil, vegetable oil or synthetic oil.

You can find beneficial features of these two types of the invention in the subclaims.

A particular feature of the invention ensures that classification takes place in a spiral channel (sorting spiral) or a sorting centre in the wet separation stage. A liquid film flow is generated when using a spiral channel or sorting centre is used where the components are separated in the liquid film as is well known. In particular, it has come to light that a spiral channel (also called a sorting spiral) is definitely suited to separating the mixture of minerals according to size in the form of a suspension. The classic case for using a sorting spiral is density separation. However, the individual particles or grains are enlarged by agglomerating solid particles using the aforementioned oil bridge formation where it has come to light that a spiral channel can achieve a great deal according to size even in terms of separation. That means that one portion can be discharged when classifying in a spiral channel that encompasses the agglomerates and a second portion, namely the fine material that essentially only consists of gangue. The same also applies when using what are known as sorting centres; they can also be separated according to the size of the particles agglomerates.

It is projected in accordance with another feature of the invention to add a gas such as air, in particular in the form of intimately disseminated bubbles, to the mixture of minerals before the wet separation stage in the solution saturated with valuable substances and gangue. This brings about the following:

There is a wide variety of particles or grains of varying sizes in the mixture of minerals, in particular a large number of particles that only consist of gangue and relatively few particles that have a proportion of valuable substances along with gangue. That means that the gangue is intertwined with the proportion of valuable substances in these particles or grains. Now, it has been described elsewhere that the objective of conditioning is producing what is known as liquid bridge bonding (oil bridge) for agglomeration, either with a hydrophobic agent on the one hand with a proportion of anionic and amphiphilic molecules or on the other hand a cationic tenside and an oil between said particles that have a proportion of valuable substances along with gangue. However, if the proportion of particles is greater in the mixture of minerals consisting 100% of gangue, then the probability that all of the particles that have both gangue and a proportion of valuable substances collide when blending the suspensions of the mixture of minerals to agglomerate by means of forming the oil bridge described, i.e. the probability of contact is relatively low. Injecting intimately disseminated air bubbles into the suspension ensures that the air bubbles dock on the superficial proportion of valuable substances hydrophobing due to the process materials as an additional contact partner. The consequence of this is that these solids particles are agglomerated with air bubbles, which enlarges the particles in the same fashion. Although the density of the agglomerates with the particles that are bonded with one another by means of an oil bridge and those that enter into a bond with an air bubble differ thoroughly (i.e., there is separating feature due to the difference in density), it is possible to jointly separate them according to size in a spiral channel into a fraction enriched with valuable substances. Any separation only according to density would not achieve our goal conceptually since the particles of the fraction containing valuable substances differ substantially in terms of density. That means that it has come to light that a spiral channel (or also a sorting centre) can separate them according to size in spite of the difference in density, indeed also economically.

The diagram of this process illustrates the invention below as an example.

For a description of the invention, the assumption is made that there is a mixture of minerals that has already gone through a separating process, for instance a residual fraction with a 2%-3% proportion of valuable substances that is the result of previous flotation. It would also be conceivable to take an initial mixture of minerals that was separated when dry. In any event, the mixture of minerals shows a gangue fraction that is essentially pure and contains a second component with a proportion of valuable substances and gangue. The single figure shows particles or grains that have a high level of gangue and a relatively small proportion of valuable substances either from pure gangue or as intermingled grain. In the event that the mixture of minerals is not available as a suspension, it has to be suspended for the subsequent conditioning process. That means that a solution saturated with the valuable substances and gangue is added.

A hydrophobic agent with a proportion of anionic and amphiphilic molecules is added to this suspension in the course of subsequent conditioning in accordance with the first type that is the subject matter of claim 1. In accordance with another type, it is projected to add a cationic tenside and an oil of this suspension (claim 6) where the cationic tenside and the oil can be added as a mixture or separately. The mixture of minerals is fed to a wet separation stage with a liquid film flow, for instance a sorting centre or spiral channel, after blending the suspension and adding the aforementioned agents for the purpose of agglomerating particles containing valuable substances. Here, the gangue fraction is essentially separated completely from the fraction containing valuable substances. This fraction containing valuable substances is fed to wet comminution where a classifying stage, for instance with agitator flotation, follows after wet comminution. It would also be conceivable to use a spiral channel or sorting centre for separating the fraction containing valuable substances from the gangue fraction.

There are several examples below for explaining this invention. Example 1 here refers to claim 1 whereas examples 2-4 refer to claim 4.

### EXAMPLE 1

After stirring in 20 drops of cold pressed rapeseed oil into a suspension consisting of 50 g of calcite and quartz each with a granulation of 0.3-0.8 and 200 ml of drinking water, more than 65% of the calcite separated on a sorting conveyor into the light fraction with a calcite content in excess of 95% (claim 1).

### EXAMPLE 2

A suspension consisting of 200 g of KCl, 400 g of NaCl of the granulation<1 mm and 800 ml of KCl and NaCl of saturated solution was placed in a laboratory flotation system. Correspondingly using 70 mg of fatty amines and 10 mg of supplemental foaming agent per kg of solids, the KCl was selectively hydrophobised and subsequently floated out as well as possible. 5 drops of cold pressed rapeseed oil were added to the residue at 3.9% of KCl in the form of a 30% oil emulsion and the emerging agglomerates were floated out. This made it possible to reduce the KCl content of the residue to 1.5%. (claim 4).

### EXAMPLE 3

5 drops of cold pressed rapeseed oil in the form of a 30% oil emulsion was added to the dirt of the granulation<1.5 mm with 600 g of solids of a company potash flotation system with 1.6% of K₂O and the resulting agglomerates were floated out with a laboratory flotation system. This made it possible to reduce the K₂O content of the residues to 1.1% (claim 4).

### EXAMPLE 4

2.03 t/h of solids (suspension with 25 weight % of solids) was conditioned with 135 g of kerosene and 100 g of a 2.5% fatty amine solution to the dirt of the granulation<1.5 mm of a company potash flotation system with 2.1% of K₂O while running in circular motion through a sorting spiral (spiral channel) and forced-air ventilation system. This made it possible to separate 60% of the residue quantity on the level of 1.0 K₂O; the comparable value without conditioning was 1.3% of K₂O with 60% mass discharge. (claim 4).

1. A process for reducing a loss of a valuable substance in a mineral preparation, the process comprising:
suspending a mixture of minerals, which comprises a grain-size category with a gangue and a superficial proportion of said valuable substance after a first separation stage dry or suspended, where the gangue is in excess of the proportion of said valuable substance, where the mixture of minerals is suspended with the proviso that the mixture of minerals is not already available as a suspension for agglomerating grains of the grain-size category with the proportion of said valuable substance,
adding at least one anionic tenside and at least one oil to the suspended mixture of minerals for wetting surface of the proportion of said valuable substance for liquid bridge formation between the proportion of said valuable substance of the grains,
transferring the mixture of minerals in a wet separation stage into a solution saturated in the proportion of said valuable substance and gangue for classification into a fraction that has less said valuable substance and a fraction that has more said valuable substance with the aid of a liquid film flow in the wet separation stage,
wet comminuting the fraction with a greater enrichment of said valuable substance and that is discharged from the wet separation stage, and
feeding the wet comminuted fraction to another classification stage.

2. The process of claim 1,
wherein
the at least one oil comprises a free fatty acid.

3. The process of claim 2,
wherein the free fatty acid is an oleic acid.

4. The process of claim 1,
wherein the at least one oil comprises at least one anionic tenside.

5. The process of claim 1,
wherein at least one anionic tenside is added to the at least one oil.

6. A process for reducing a loss in a valuable substance in a mineral preparation, the process comprising:
suspending a mixture of minerals, which comprises a grain-size category with one gangue and a superficial proportion of said valuable substance after an initial separation stage dry or suspended, where the gangue is in excess of the proportion of said valuable substance, where the mixture of minerals is suspended with the proviso that the mixture of minerals is not already available as a suspension for agglomerating grains of the grain-size category with the proportion of said valuable substance,
adding at least one cationic tenside and at least one oil and/or at least one volatile substance extracted from petroleum to the suspended mixture of minerals for wetting surface of the proportion of said valuable substance for forming a liquid bridge between the proportions of said valuable substance of the grains,
transferring the mixture of minerals in a wet separation stage into a solution saturated on the proportion of said valuable substance and gangue for classification into a fraction that has less said valuable substance and a fraction that has more said valuable substance with the aid of a liquid film flow,
wet comminuting the fraction that is more greatly enriched with said valuable substance and that is discharged from the wet separation stage, and
feeding the wet comminuted fraction to another classification stage.

7. The process of claim 6,
wherein the at least one cationic tenside and the at least one oil are added as a mixture or separately.

8. The process of claim 6,
wherein the at least one cationic tenside is a fatty amine.

9. The process of claim 6,
wherein the at least one oil is a vegetable oil.

10. The process of claim 6,
wherein the at least one volatile substance extracted from petroleum is kerosene or diesel.

11. The process of claim 1,
wherein the wet comminuted fraction is classified by flotation.

12. The process of claim 6,
which is a separation of silvine from a mixture of salt.

13. The process of claim 1,
which is a separation of calcite from a mixture containing quartz.
